(19) United States
(12) Patent Application Publication
(10) Pub. No.: US 2004/0008198 A1
(43) Pub. Date: Jan. 15, 2004

(54) Three-dimensional output system

(76) Inventor: John Gildred, Oakland, CA (US)

Correspondence Address: DVA/PIONEER RESEARCH CENTER USA, INC., INTELLECTUAL PROPERTY DEPARTMENT, 2355 MAIN STREET, SUITE 200, IRVINE, CA, 92614, US

(21) Appl. No.: 10/064,157

(22) Filed: Jun. 14, 2002

(51) Int. Cl. H04N 7/173; G06T 15/00

(52) U.S. Cl. 345/419; 345/582

(57) ABSTRACT

The three-dimensional graphical rendering of a live broadcast signal onto an output device such as a television or a monitor is described herein. The three-dimensional graphical rendering is performed by a set-top box or other device that has a graphics processor. In operation, a live broadcast signal is provided as input to the set-top box or other graphical rendering device. The signal initially is in the form of uncompressed video data from a video decoder or other YUV video source. The signal can be for use with a conventional television system, a high definition television system (HDTV), a computer system with a monitor, or any other applicable output device. The uncompressed video data is mapped to a texture memory in the graphics processor. The video data is then rendered to a three-dimensional surface and displayed on an output device, for example a television screen. In one aspect of the invention, the output device provides a three-dimensional user interface that displays menus, program guides, allows users to change channels, displays video, pauses and rewinds live television, and otherwise provides all of the elements typically found on modern interface screens.

### COPYRIGHT STATEMENT

All of the material in this patent document is subject to copyright protection under the copyright laws of the United States and of other countries. Portions of the material in this patent document are also subject to protection under the maskwork registration laws of the United States and of other countries. The owner of the copyright and maskwork rights has no objection to the facsimile reproduction by anyone of the patent document or the patent disclosure, as it appears in the United States Patent and Trademark Office file or records, but otherwise reserves all copyright and maskwork rights whatsoever.

### BACKGROUND OF INVENTION

1. Field of the Invention

The present invention relates generally to broadcast systems, and more particularly, to establishing a three-dimensional broadcast environment and methods of using the three-dimensional broadcast environment once it is established.

2. Background of the Invention

Broadcast systems, such as live television systems are configured to receive a signal and translate the signal in real time to pictures that appear on an output device, such as a two-dimensional television screen. One drawback with current live broadcast systems is that there is little or no opportunity to operate, modify, or otherwise enhance the image that is to be output to the screen. The output device (e.g., television set) simply displays the image represented in the live signals it receives with little or no modification.

A computer graphics system, on the other hand, is able to create an image that appears to be three-dimensional on a two-dimensional surface. A computer graphics system uses mathematical formulas to alter the image, for instance by warping, bending, blurring, morphing, rotating, or changing the colors and textures of the image. As broadcast systems and computer graphics systems develop in parallel, both are capable of producing a picture that is of a quality suitable for live broadcast via a television or other output device. The advantages typically associated with a computer graphics system, however, are never harnessed when a user watches a live broadcast. Before further discussing this problem an overview is provided.

Broadcast System

An output device, such as a television screen commonly used with a broadcast system, is a collection of tiny dots or pixels. When a still image on the television screen is presented in the form of a collection of pixels, the human brain reassembles the dots into a meaningful image. Furthermore, television systems divide a moving scene is into a sequence of still pictures shown in rapid succession. When this happens the brain re-assembles the still images into a single moving scene.

There are several different ways to get a live signal into a television set. Broadcast programming can be received through an antenna. Alternatively, VCR or DVD content can be run from the VCR or DVD player to the antenna terminals. A satellite-dish antenna can also be used to receive a signal and deliver it to a set-top box that connects to the antenna terminals. A cable television signal can also be delivered to a set-top box that connects to the antenna terminals. All of these methods are known to those skilled in the art, but a system, which delivers a television signal to a set-top box is described in more detail below.

Set-Top Box

FIG. 1 illustrates a system, which includes a set-top box 10 that is connected to a conventional TV 20 via a transmission line 30. TV signals are received by the set-top box 10 via transmission line 40, which may be connected to either an antenna or a cable television outlet. Set-top box 10 receives conventional AC power through a line 50. Set-top box 10 receives user input entered from a handheld remote control 60 over a wireless link 70. Wireless link 70 may be an infrared (IR) link, a radio frequency (RF) link, or any other suitable type of link. A bi-directional data path 80 is provided to set-top box 10, through which set-top box 10 can access the Internet 90.

FIG. 2 illustrates a block diagram of the internal components of set-top box 10. Note that FIG. 2 is intended to be a conceptual diagram and does not necessarily reflect the exact physical construction and interconnections of these components. Set-top box 10 includes processing and control circuitry 200, which controls the overall operation of the system. Coupled to the processing and control circuitry 200 are a TV tuner 210, a memory device 220, a communication device 230, and a remote interface 240.

TV tuner 210 receives the television signals on transmission line 260, which may originate from an antenna or a cable television outlet. Processing and control circuitry 200 provides audio and video output to TV set 20 via a line 270. Remote interface 240 receives signals from remote control 60 via wireless connection 70. Communication device 230 is used to transfer data between set-top box 10 and one or more remote processing systems, such as a web server 280, via a data path 290.

Processing and control circuitry 200 may include one or more of devices such as general-purpose microprocessors, digital signal processors (DSPs), application specific integrated circuits (ASICs), various types of signal conditioning circuitry, including analog-to-digital converters, digital-to-analog converters, input/output buffers, etc. Memory device 220 may include one or more physical memory devices, which may include volatile storage devices, non-volatile storage devices, or both. For example, memory 220 may include both random access memory (RAM), read-only memory (ROM), various forms of programmable and/or erasable ROM (e.g., PROM, EPOM, EEPROM, etc.), flash memory, or any combination of these devices.

Communication device 230 may be a conventional telephone (POTS) modem, an Integrated Services Digital Network (ISDN) adapter, a Digital Subscriber Line (xDSL) adapter, a cable television modem, or any other suitable data communication device. Note that in various other embodiments, other components may be added to the system, either as components of set-top box 10 or as peripheral devices. Such components might include, for example, a keyboard, a mass storage device, or a printer. Such components may be connected via a physical connection or by a wireless connection (e.g., a wireless keyboard).

Computer Graphics Environment

Computers are often used to display graphical information. In some instances, graphical data or images are rendered by executing instructions in a three-dimensional graphics chip that is drawing the data or image to a display. An image is a regular two dimensional array in which every element of the array is a digital quantity of energy such as light/heat/density, etc. A displayed image may be made up of a plurality of graphical objects. Examples of graphical objects include points, lines, polygons, and three-dimensional solid objects.

As with a television screen, a computer display is made up of pixels. The color of each pixel is represented by a number value. To store an image in a computer memory, the number value of each pixel of the picture is stored. The number value represents the color and intensity of the pixel. During pixel rendering, color and other details can be applied to areas and surfaces of objects using texture mapping techniques. In texture mapping, a texture is mapped to an area or surface of a graphical object to produce a visually modified object with the added detail of the texture image. As an example of texture mapping, given a featureless graphical object in the form of a cube and a texture image defining a wood grain pattern, the wood grain pattern of the texture image may be mapped onto the cube such that the cube appears to be made out of wood.

Advantages in a Computer Graphics Environment

A computer graphics environment is advantageous because every pixel on the screen is given a value that a computer can control. For instance, returning to the example of a wood textured cube, it is relatively simple to morph the globe into a wood grained cone. Likewise, the texture of the cone can be modified to appear as the texture of marble and the cone can be rotated, moved, or exploded, for instance. Once a three-dimensional graphical environment is established it can be controlled by a computer system, and the alterations or 3D graphics operations one can perform in the environment are only limited by the imagination of the operator.

A broadcast system environment on the other hand, offers no opportunity to modify the pixels that are output to the screen. The broadcast environment is static. The values that are fed into the system are essentially the same values output to the screen. Some schemes have attempted to harness some 3D graphics capabilities in the context of a broadcast show. One scheme involves the pre-production creation of 3D graphics and effects and the combination of the 3D rendered images with a video signal. Then using a time delay the combined signal is sent to an output device as a live broadcast signal. This is seen, for instance where a television company (e.g., NBC, CBS, ABC, or FOX) inserts their logo, for instance a spinning globe and combines it with the broadcast image. The combined signal is then stored away and when it is time to show the image, the frames are inserted into the live signal. This scheme is limited because to perform the scheme there must be sufficient time to pre-produce and insert all of the 3D graphics. Therefore, this scheme cannot occur on the fly and its applicability to a live broadcast is severely constrained.

Another scheme overlays three-dimensional graphics images over a broadcast signal. Using this method it is possible to use the advantages of three-dimensional graphics, but only on a portion of the image is usable. This method also depends on pre-planned overlays and the manipulations must also be planned in advance of the broadcast of the live signal. As such, this method is limited and cannot be used for live broadcasts. Therefore, this method fails to fully harness the advantages of a 3D graphics environment in the context of a live broadcast.

Moreover, these schemes rely on 3D graphics operations at the studio level. This means that all of the 3D graphics are created in a studio or production facility prior to the broadcast and then finalized and sent as a broadcast signal. These schemes offer no manner in which to perform 3D graphics operations at the location where the signal has reached the viewer's in-home equipment (i.e., a set-top box). For these reasons, it would be beneficial to apply the techniques made possible in a three-dimensional graphical environment of a computer and apply those techniques to a live broadcast signal.

### SUMMARY OF INVENTION

The present invention is directed to the three-dimensional graphical rendering of a live broadcast signal onto an output device such as a monitor or a television screen. The three-dimensional graphical rendering is performed by a set-top box or other device that has a graphics processor. In operation, a broadcast signal (provided, for instance, as a live television signal, a video on demand broadcast, or a download of Internet content) is provided as input to the set-top box or other graphical rendering device. The signal initially is in the form of uncompressed video data from a video decoder or other YUV video source. The signal can be for use with a monitor, conventional television system, a high definition television system (HDTV), or any other applicable output device. The uncompressed video data is mapped to a texture memory in the graphics processor. The video data is then rendered to a three-dimensional surface and displayed on an output device.

In one aspect of the invention, the output device provides a three-dimensional user interface that displays menus, program guides, allows users to change channels, displays video, pauses and rewinds live television, and otherwise provides all of the elements typically found on modern broadcast interface screens.

In one embodiment of the invention, a series of three hardware chips is used. First, the live broadcast signal is received in a video decoder chip. The video decoder chip passes its uncompressed video output to an intermediate chip whose responsibility is to push the output of the video decoder into a texture memory of a three-dimensional graphics chip, for instance by direct memory address (DMA) transfer. The information in the texture memory of the graphics chip is then used to render three-dimensional graphics to the screen of the output device.

### BRIEF DESCRIPTION OF DRAWINGS

The invention will be more fully understood by reference to the following drawings, which are for illustrative purposes only:

FIG. 1 is a functional block diagram showing a prior art television system.

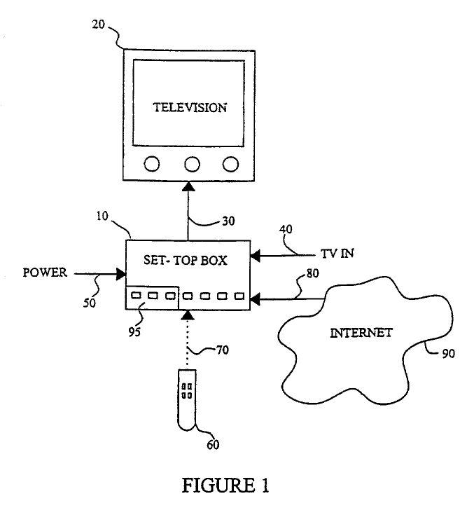

FIG. 2 is a functional block diagram showing a prior art television system and highlighting the internal components of a set-top box.

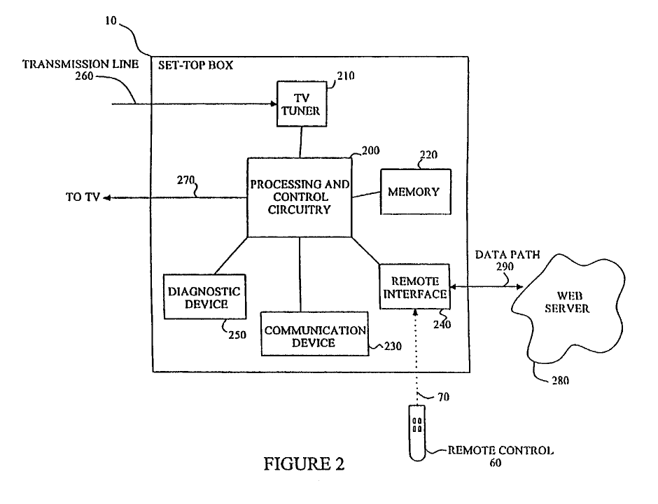

FIG. 3 is a functional block diagram of an embodiment of the present invention.

FIG. 4 is a functional block diagram of another embodiment of the present invention.

FIG. 5 is a diagram of a hardware embodiment of the present invention.

FIG. 6 is a diagram of another hardware embodiment of the present invention.

FIG. 7 is a diagram of another hardware embodiment of the present invention.

FIG. 8 is a diagram of another hardware embodiment of the present invention.

FIG. 9 is a flowchart showing how user interface elements are incorporated into a system according to an embodiment of the present invention.

FIG. 10 is a flowchart showing how surface mapping is used by an embodiment of the present invention.

FIG. 11 is a flowchart showing how transition events are handled by an embodiment of the present invention.

FIG. 12 is a functional diagram showing how surface mapping is used in conjunction with a live broadcast according to an embodiment of the present invention.

### DETAILED DESCRIPTION

The present invention is directed to the three-dimensional graphical rendering of a live broadcast signal onto an output device. The three-dimensional graphical rendering is performed by a set-top box or other device that has a graphics processor. In operation, a live broadcast signal is provided as input to the set-top box or other graphical rendering device. The signal initially is in the form of uncompressed video data from a video decoder or other YUV video source. The signal can be for use with a conventional television system, a high definition television system (HDTV), a monitor, or any other applicable output system. The uncompressed video data is mapped to a texture memory in the graphics processor. The video data is then rendered to a three-dimensional surface and displayed on a screen of the output device. In one aspect of the invention, the screen provides a three-dimensional user interface that displays menus, program guides, allows users to change channels, displays video, pauses and rewinds live television, and otherwise provides all of the elements typically found on modern interface screens.

In one embodiment of the invention, a series of three hardware chips is used. First, the live broadcast signal is received in a video decoder chip. The video decoder chip passes its uncompressed video output to an intermediate chip whose responsibility is to push the output of the video decoder into a texture memory of a three-dimensional graphics chip, for instance by direct memory address (DMA) transfer. The information in the texture memory of the graphics chip is then used to render three-dimensional graphics to the output screen.

Hardware Embodiments

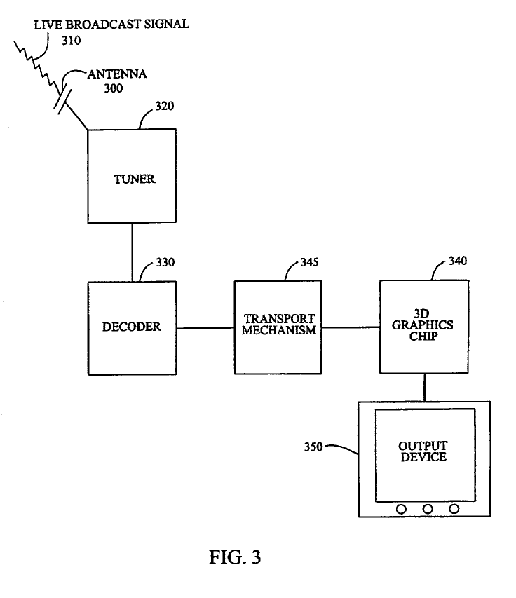

Referring more specifically to the drawings, for illustrative purposes the present invention is embodied in the block diagram shown in FIG. 3. FIG. 3 shows a system where an antenna 300 receives a broadcast signal 310. Broadcast signal 310 is sent to a tuner 320 and then to a video decoder 330. Once the signal is decoded it is output to a three-dimensional graphics chip 340 via a transport mechanism 345 and then sent to an output device 350. Transport mechanism 345 is a bus or another chip configured to pull video data from decoder 330 and push it to graphics chip 340.

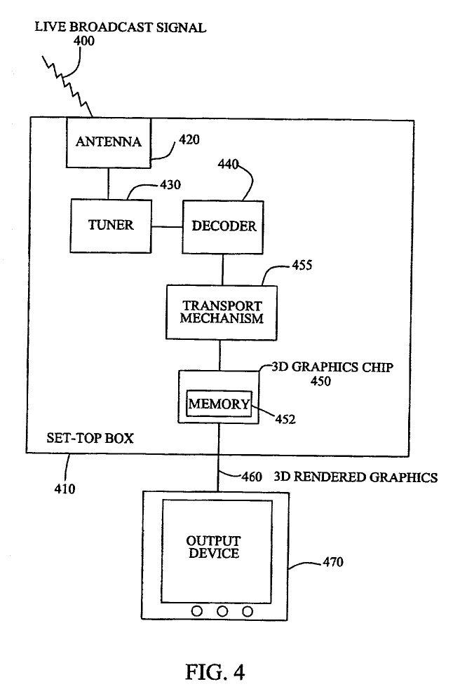

Another embodiment of the present invention is shown in the block diagram of FIG. 4. A live broadcast signal 400 is sent to a set-top box 410. An antenna 420 receives the signal and a tuner 430 tunes the signal and passes it to a decoder 440. The decoder 440 sends the decoded signal, usually in the form of a YUV decompressed video frame, to a memory 452 of a three-dimensional graphics chip 450 via a transport mechanism 455. The graphics chip 450 outputs three-dimensional rendered graphics 460 to output device 470.

Synchronization Mechanism

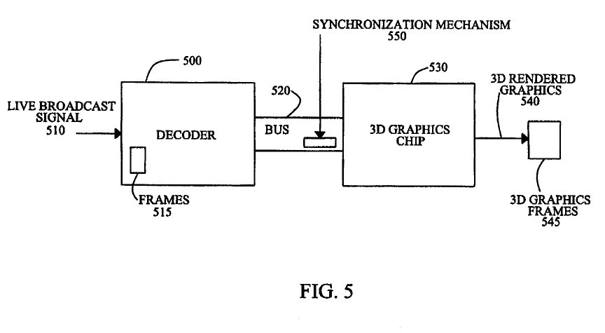

FIG. 5 is a block diagram showing more detail as to the operation of the hardware according to one embodiment of the present invention. Hardware decoder 500 receives a live broadcast signal 510 that has been received by an antenna and tuned. The live broadcast signal comprises a number of frames 515 that when combined cause the human brain to perceive a moving image. A bus 520 connects hardware decoder 500 to three-dimensional graphics chip 530. Bus 520 may be a PCI bus or other suitable bus and it typically transports YUV decompressed video frames. The three-dimensional graphics chip 530 outputs three-dimensional rendered graphics 540. The three-dimensional rendered graphics 540 comprise a number of three-dimensional rendered graphics frames 545. Each frame is rendered using conventional 3D rendering techniques, such as receiving vertices for all of the shapes on the screen, rendering the shapes, mapping texture to the shapes, adding lighting effects to the textured shapes, etc.

A synchronization mechanism 550 is used to ensure that for each frame 515 that enters the system, a three-dimensional rendered graphics frame 545 is output by the system. Currently, the industry standard is 30 frames per second although this rate is not necessary to carry out the invention. Synchronization mechanism 550 ensures that for each frame that enters the system, the bus 520 transports the frame to the three-dimensional graphics chip 530 at the same rate, so that frames are rendered to the screen at the same rate they enter the system and so the user is unaware that they are actually viewing three-dimensional rendered graphics. In other words, the three-dimensional output system according to the present invention normally appears exactly as a conventional broadcast (e.g., television) system appears and is unnoticeable when the three-dimensional rendered frames are otherwise unmodified by a three-dimensional graphics operation.

Chip Configurations

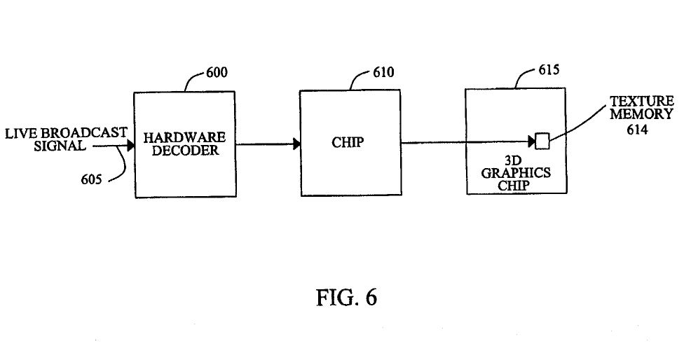

The chip configurations used by embodiments of the present invention are shown in FIGS. 6-9. In one embodiment shown in FIG. 6, a hardware decoder 600 receives a live broadcast signal 605 that has been received by an antenna and tuned. A chip 610 connects hardware decoder 600 to three-dimensional graphics chip 615. The chip 610 is used to pull frames in the form of uncompressed video data from the decoder 600 and push them to a texture memory 614 of three-dimensional graphics chip 615.

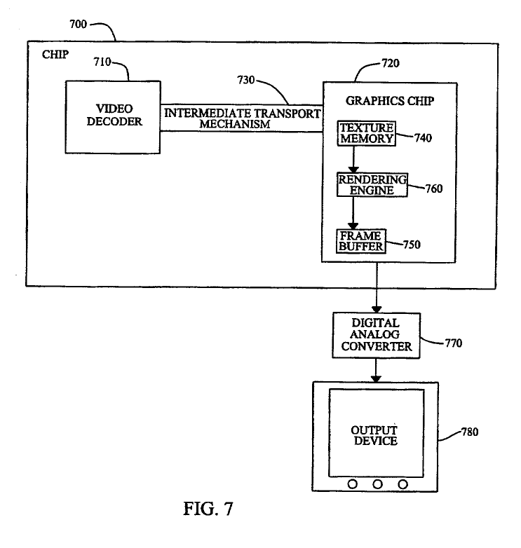

In another embodiment, shown in FIG. 7, the entire arrangement resides in a single chip 700. Chip 700 has a video decoder 710, a graphics chip 720, and an intermediate transport mechanism 730 such as a PCI bus or other hardware chip for pulling decoded video and pushing it to the graphics chip 720. The graphics chip 720 includes a texture memory 740 where transport mechanism pushes the uncompressed video data. The graphics chip also includes a frame buffer 750 where the final values to be output to the screen are stored. A rendering engine 760 receives the video data in the texture memory 740 and renders the three-dimensional graphics and stores the final values in the frame buffer 750. The final values are the end result to be viewed by the user of the output device. It contains a flat image with geometry and light characteristics. These final values are then taken from the frame buffer at the appropriate time, passed through a digital to analog converter 770, and displayed on an output device 780.

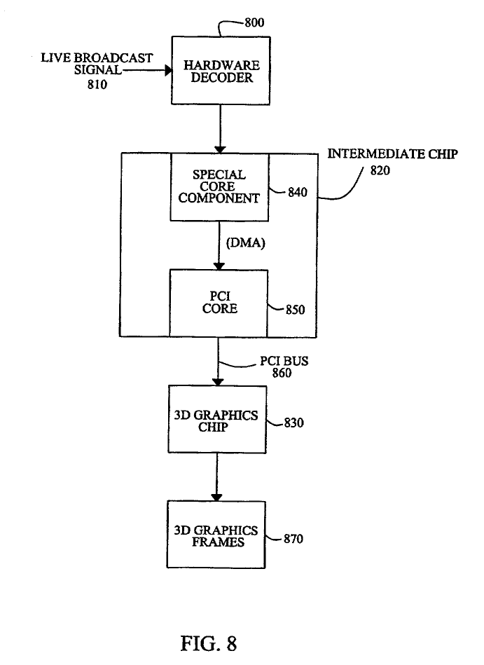

In another embodiment shown in FIG. 8, a hardware decoder 800 receives a live broadcast signal 810 that has been received by an antenna and tuned. An intermediate chip 820 connects hardware decoder 800 to three-dimensional graphics chip 830. The intermediate chip 820 contains a special core component 840. Special core component 840 may be written in the Verilog hardware description language or other suitable programming language. The purpose of the special core component 840 is to grab frames that have been broadcast and received at the decoder 800 and to move them to a PCI core 850 in intermediate chip 820 (for instance by DMA transfer) and to move them to PCI bus 860.

Special core component 840 ensures that it grabs frames in a manner which corresponds to the rate in which frames are distributed during live broadcasts so that three-dimensional graphics chip 830 receives frames from PCI bus 860 fast enough so that it can render a three-dimensional graphics frame 870 and output it to the output device. In one embodiment, the special core component 840 receives YUV high definition output from the decoder 800 across a VIP bus 880.

User Interface (UI) Elements

The hardware embodiments discussed above refer to some of the hardware needed to establish a three-dimensional output environment. UI elements refer to some of the advantages that exist once such an environment is established. UI elements relate to what one is able to do with the environment. These UI elements include, for instance interaction with on-screen menus in conjunction with a live broadcast, use of interactive program guides, changing channels with a remote control, displaying video whether recorded or live and interacting with the video, for instance by pausing or rewinding the video, and otherwise providing all of the elements typically found on an output interface screen.

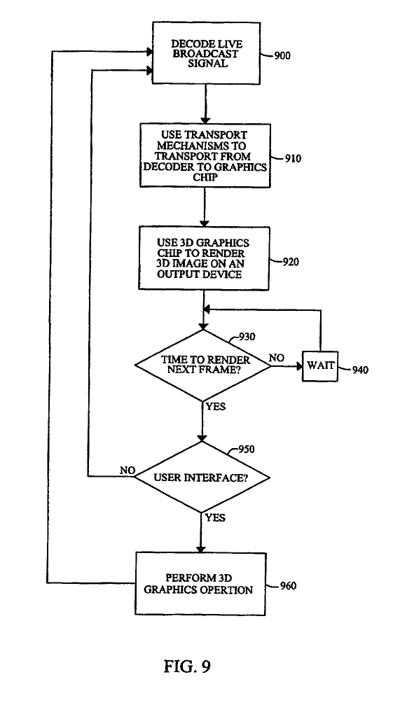

Generally, the flowchart of FIG. 9 shows how UI elements are used in a three-dimensional output environment. At step 900, live broadcast signals are decoded. At step 910, the signals are transported from the decoder to a graphics chip using a transport mechanism. At step 920, the graphics chip renders a three-dimensional graphics image on an output device. At step 930, a synchronization mechanism determines if it is time to render another frame in the three-dimensional graphics image. If not, the system waits at step 940 and step 930 repeats. When step 930 is true, it is determined at step 950 if a UI event has occurred.

A UI event is, for instance, a change of the channel, pausing of live or recorded television, initiating a menu or program guide, or otherwise providing input to the systrem (e.g., with a remote control, keyboard, or mouse). If a UI event is not occurring, then step 900 repeats. If a UI event is occurring, then a three-dimensional graphics operation occurs at step 960 and step 900 repeats. A three-dimensional graphics operation generally includes any operation used in a three-dimensional graphics environment. This includes, for instance, a rotation of video, a shatter effect, a shifting effect, a warping, a surface mapping, having video fly across the screen, having a motion blur, creating an explosion, etc.

Surface Mapping

Once a three-dimensional output environment is established on a flat screen it can be manipulated so that it is mapped onto another 3D surface. This is useful, for instance, when a UI event is one where a user changes channels. One example would be to sense when a user is changing channels on their remote or pausing live television. Once this event occurs, the live image is mapped from the flat screen to a cube or sphere, for instance. In the case of a channel change, the cube or sphere is then be rotated and the next channel is mapped to the back portion of the geometric shape. As the shape rotates through 360 degrees, the new channel rotates to the front and is then re-mapped to the flat screen, where normal viewing resumes. In the case of a pause operation the current frame is mapped to the surface, the surface is rotated, and when the pause is ended, the next frame rotates to the front and is mapped back to the flat screen.

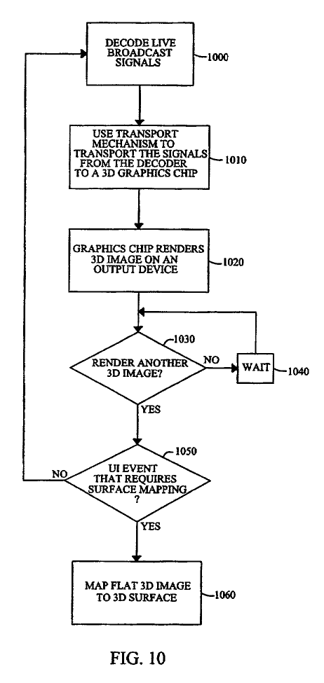

The flowchart of FIG. 10 shows how surface mapping is used by an embodiment of the present invention. At step 1000, live broadcast signals are decoded. At step 1010, the signals are transported from the decoder to a graphics chip using a transport mechanism. At step 1020, the graphics chip renders a three-dimensional graphics image on an output device. At step 1030, a synchronization mechanism determines if it is time to render another frame in the three-dimensional graphics image. If not, the system waits at step 1040 and step 1030 repeats. When step 1030 is true, it is determined at step 1050 if a UI event has occurred that requires a surface mapping. If such a UI event is not occurring, then step 1000 repeats. If a surface mapping event is required, then a flat image is mapped to a three-dimensional surface at step 1060 and step 1000 repeats.

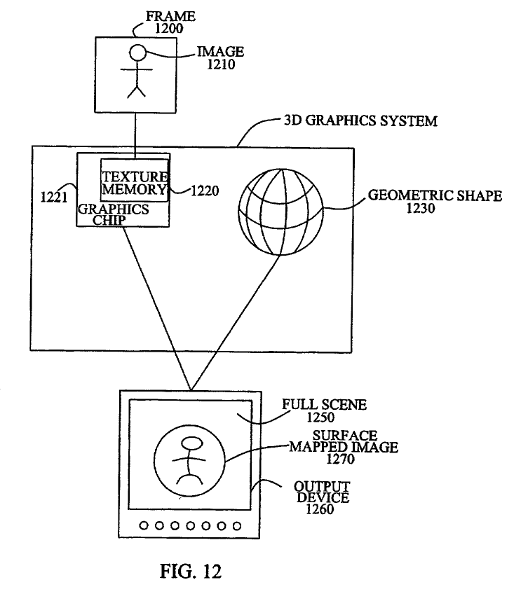

FIG. 12 is a functional diagram that shows how surface mapping techniques are used in conjunction with live broadcast according to one embodiment of the present invention. Broadcast signal video frame 1200 has an image 1210 within the frame. The frame 1200 is transported to a texture memory 1220 of a graphics chip 1221. A geometric shape 1230 is defined. A 3D graphics system 1240 takes the information defining geometric shape 1230 and the bitmap information defining video frame 1200 and combines the two into a full scene 1250 on an output device 1260 wherein the full scene 1250 has a surface mapped image 1270 on it. Surface mapped image is now in a position to undergo a 3D graphics operation such as a rotation, explosion, warping, etc.

Transition Events

One advantage to mapping a live broadcast signal to a 3D graphics environment is to perform 3D operations to the live signal when a transition event occurs. One example of a transition event is a channel change. Upon the occurrence of a transition event, some form of 3D operation occurs. For example, upon a channel change transition event, the current frame can be caused to explode or shatter with the next channel's frame replacing the exploded frame.

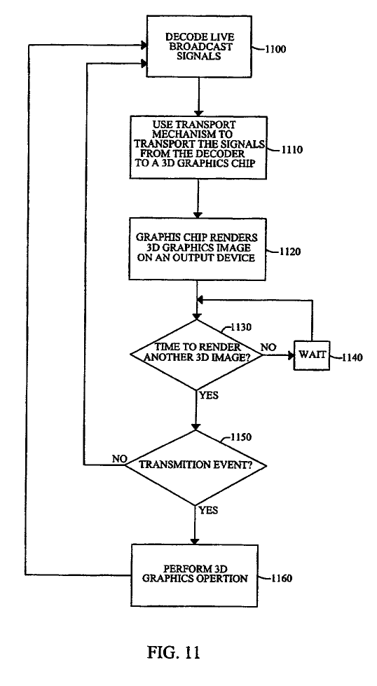

FIG. 11 is a flowchart that shows how transition events are handled by an embodiment of the present invention. At step 1100, live broadcast signals are decoded. At step 1110, the signals are transported from the decoder to a graphics chip using a transport mechanism. At step 1120, the graphics chip renders a three-dimensional graphics image on an output device. At step 1130, a synchronization mechanism determines if it is time to render another frame in the three-dimensional graphics image. If not, the system waits at step 1140 and step 1130 repeats. When step 1130 is true, it is determined at step 1150 if a transition event has occurred, such as a channel change. If such a transition event is not occurring, then step 1100 repeats. If a transition event is required, then a 3D graphics operation occurs at step 1160 (such as an explosion or shatter effect) and step 1100 repeats.

Although the description above contains many specificities, these should not be construed as limiting the scope of the invention but as merely providing illustrations of some of the presently preferred embodiments of this invention. Thus the scope of this invention should be determined by the appended claims and their legal equivalents.

1. A three-dimensional output system comprising: a hardware decoder that receives live broadcast signals and outputs video frames; a three-dimensional graphics chip having a texture memory that transforms said video frames to three-dimensional graphics frames and outputs said three-dimensional graphics frames to an output device; and a transport mechanism that obtains said video frames from said decoder and transports said frames to said texture memory of said three-dimensional graphics chip.

2. The system of claim 1 further comprising: a synchronization mechanism that synchronizes the output of said video frames from said decoder and the output of said three-dimensional graphics frames to said output device.

3. The system of claim 1 wherein said transport mechanism comprises a PCI bus.

4. The system of claim 1 wherein said output device is a television set.

5. The system of claim 1 wherein said output device is a monitor.

6. The system of claim 2 wherein said synchronization mechanism ensures that said output of said video frames and said output of said three-dimensional graphics frames is at a rate of approximately thirty frames per second.

7. The system of claim 1 wherein said hardware decoder, said three-dimensional graphics chip, and said transport mechanism reside in a set-top box.

8. The system of claim 7 wherein said hardware decoder, said three-dimensional graphics chip, and said transport mechanism are all components of a single chip.

9. The system of claim 7 wherein said hardware decoder, said three-dimensional graphics chip, and said transport mechanism are all components on separate chips.

10. The system of claim 1 wherein said transport mechanism transports said frames to said texture memory from said decoder using a direct memory address (DMA) transfer.

11. The system of claim 1 wherein said transport mechanism further comprises: a special core component configured to receive a YUV decompressed video frame across a VIP bus from said hardware decoder; a PCI core configured to receive said YUV decompressed video frame from said special core component via a DMA transfer and to send said YUV decompressed video frame to a PCI bus.

12. The system of claim 11 wherein said special core component is written in a hardware definition language.

13. The system of claim 12 wherein said hardware definition language is Verilog.

14. A method comprising: decoding live broadcast signals with a decoder; transporting said live broadcast signals to a graphics chip; and rendering a three-dimensional graphics image on an output device using said live broadcast signals.

15. The method of claim 14 further comprising: synchronizing an output of said live broadcast signals from said decoder with an output of a three-dimensional graphics frame from said graphics chip.

16. The method of claim 14 wherein said step of transporting comprises, using a PCI bus.

17. The method of claim 14 wherein said output device is a television set.

18. The method of claim 14 wherein said output device is a monitor.

19. The method of claim 15 wherein said step of synchronizing ensures that said output of said live video signals and said output of said three-dimensional graphics frames is at a rate of thirty frames per second.

20. The method of claim 14 wherein said step of transporting comprises, using a direct memory address (DMA) transfer.

21. The method of claim 15, further comprising: determining if a user interface (UI) event has occurred; and performing a three-dimensional graphics operation, if said UI event has occurred.

22. The method of claim 21 wherein said UI event comprises a changing of a television channel.

23. The method of claim 21 wherein said UI event comprises a pausing of a live or a recorded television show.

24. The method of claim 21 wherein said UI event comprises initiating a menu or a program guide.

25. The method of claim 21 wherein said UI event providing input to a television set or a set-top box.

26. The method of claim 21 wherein said three-dimensional graphics operation comprises a rotation of a three-dimensional graphics frame.

27. The method of claim 21 wherein said three-dimensional graphics operation comprises a shatter effect.

28. The method of claim 21 wherein said three-dimensional graphics operation comprises a warping effect.

29. The method of claim 21 wherein said three-dimensional graphics operation comprises a surface mapping.

30. The method of claim 21 wherein said three-dimensional graphics operation comprises a motion blur.

31. The method of claim 21 wherein said three-dimensional graphics operation comprises an operation performed in a three-dimensional graphics environment.

32. A computer program product comprising: a computer usable medium having computer readable program code embodied therein comprising: computer readable program code configured to cause a computer to decode live broadcast signals with a decoder; computer readable program code configured to cause a computer to transport said live broadcast signals to a graphics chip; and computer readable program code configured to cause a computer to render a three-dimensional graphics image on an output device using said live broadcast signals.

33. The computer program product of claim 32 further comprising: computer readable program code configured to synchronize an output of said live broadcast signals from said decoder with an output of a three-dimensional graphics frame from said graphics chip.

34. The computer program product of claim 32 wherein said computer readable program code configured to transport comprises, computer readable program code configured to use a PCI bus.

35. The computer program product of claim 32 wherein said output device is a television set.

36. The computer program product of claim 32 wherein said output device is a monitor.

37. The computer program product of claim 33 wherein said computer readable program code configured to synchronize ensures that said output of said live video signals and said output of said three-dimensional graphics frames is at a rate of thirty frames per second.

38. The computer program product of claim 33 wherein said computer readable program code configured to transport comprises, computer readable program code configured to use a direct memory address (DMA) transfer.

39. The computer program product of claim 33, further comprising: computer readable program code configured to determine if a user interface (UI) event has occurred; and computer readable program code configured to perform a three-dimensional graphics operation, if said UI event has occurred.

40. The computer program product of claim 39 wherein said UI event comprises a changing of a television channel.

41. The computer program product of claim 39 wherein said UI event comprises a pausing of a live or a recorded television show.

42. The computer program product of claim 39 wherein said UI event comprises initiating a menu or a program guide.

43. The computer program product of claim 39 wherein said UI event providing input to a television set or a set-top box.

44. The computer program product of claim 39 wherein said three-dimensional graphics operation comprises a rotation of a three-dimensional graphics frame.

45. The computer program product of claim 39 wherein said three-dimensional graphics operation comprises a shatter effect.

46. The computer program product of claim 39 wherein said three-dimensional graphics operation comprises a warping effect.

47. The computer program product of claim 39 wherein said three-dimensional graphics operation comprises a surface mapping.

48. The computer program product of claim 39 wherein said three-dimensional graphics operation comprises a motion blur.

49. The computer program product of claim 39 wherein said three-dimensional graphics operation comprises an operation performed in a three-dimensional graphics environment.
